(19) United States
(12) Patent Application Publication
(10) Pub. No.: US 2022/0131134 A1
(43) Pub. Date: Apr. 28, 2022

(54) POSITIVE ELECTRODE ACTIVE MATERIAL

(71) Applicant: HONDA MOTOR CO., LTD., Tokyo (JP)

(72) Inventors: Kazuyuki SATO, Saitama (JP); Takeshi FUJINO, Saitama (JP)

(21) Appl. No.: 17/451,648

(22) Filed: Oct. 21, 2021

(30) Foreign Application Priority Data
Oct. 22, 2020 (JP) 2020-177076

(51) Int. Cl. H01M 4/36; H01M 4/525; H01M 4/505; H01M 4/04; H01M 4/62

(52) U.S. Cl. CPC H01M 4/366; H01M 4/525; H01M 4/505; H01M 2004/028; H01M 4/625; H01M 4/623; H01M 4/0402

(57) ABSTRACT

To provide a positive electrode active material capable of improving cycle characteristics of a lithium ion secondary battery and achieving a desirable discharge capacity. A positive electrode active material that is an aggregate of lithium compounds each including a lithium-containing transition metal oxide, includes particles having a surface on which a solid film including at least two of an inorganic salt including lithium, a solid particle, and an organic material, is formed.

The solid film preferably includes at least the organic material, and preferably includes all of the inorganic salt including lithium, the solid particle, and the organic material.

This application is based on and claims the benefit of priority from Japanese Patent Application No. 2020-177076, filed on 22 Oct. 2020, the content of which is incorporated herein by reference.

### BACKGROUND OF THE INVENTION

### Field of the Invention

The present invention relates to a positive electrode active material.

### Related Art

Conventionally, as secondary batteries having a high energy density, lithium ion secondary batteries are widely used.

A lithium ion secondary battery using a liquid as an electrolyte has a structure in which a separator is interposed between a positive electrode including a positive electrode active material and a negative electrode including a negative electrode active material, and a liquid electrolyte (electrolytic solution) is injected.

The lithium ion secondary battery has an issue that cycle characteristics are deteriorated by repetition of charging and discharging. In response to the issue, a technology has been proposed in which a surface of a positive electrode active material is coated with a fluorine compound to suppress side reactions between the positive electrode active material and an electrolytic solution at a high voltage and to improve cycle characteristics (for example, see Patent Document 1).

In addition to the above, a technology relating to a method for manufacturing a positive electrode material for a lithium ion secondary battery in which a film including a lithium ion conductor and a ferroelectric material is formed on at least a part of the surface of a positive electrode active material, has been proposed (for example, see Patent Document 2).

Patent Document 1: Japanese Unexamined Patent Application (Translation of PCT Application), Publication No. 2008-536285

Patent Document 2: Japanese Unexamined Patent Application, Publication No. 2018-147726

### SUMMARY OF THE INVENTION

In the technology disclosed in Patent Document 1, since the surface of the positive electrode active material is coated with the fluorine compound, the conductivity of lithium ions becomes insufficient, the reaction resistance increases, and the output decreases.

In the technology disclosed in Patent Document 2, since the film formed on the surface of the positive electrode active material is a composite film consisting of inorganic solids only, cracking and peeling occur due to the volume change of the positive electrode active material caused by charging and discharging, and sufficient cycle durability cannot be obtained. The above issue is more pronounced when a positive electrode active material with a high nickel ratio is used as the positive electrode active material. Further, if the particle size of the ferroelectric material disclosed in Patent Document 2 is too small, the resistance reduction effect cannot be sufficiently obtained. If the particle size of the ferroelectric material is too large, the adhesiveness to the positive electrode active material decreases. Therefore, it is difficult to adjust the particle size to obtain a desirable effect.

In response to the above issues, it is an object of the present invention to provide a positive electrode active material capable of improving cycle characteristics of a lithium ion secondary battery and achieving a desirable output.

(1) A first aspect of the present invention relates to a positive electrode active material that is an aggregate of lithium compounds each including a lithium-containing transition metal oxide. The positive electrode active material includes particles having a surface on which a solid film including at least two of an inorganic salt including lithium, a solid particle, and an organic; material, is formed.

According to the invention of the first aspect, it is possible to provide a positive electrode active material capable of improving the cycle characteristics of a lithium ion secondary battery and achieving a desirable discharge capacity.

(2) In a second aspect of the present invention according to the first aspect, the solid film includes at least the organic material.

The invention according to the second aspect can improve the durability of a positive electrode active material by preventing an inorganic salt including lithium and a solid particle from failing off and preventing contact between an electrolytic solution and the positive electrode active material.

(3) In a third aspect of the present invention according to the first or second aspect, the solid film includes the Inorganic salt including lithium, the solid particle, and the organic material.

According to the invention of the third aspect, it is possible to obtain a positive electrode active material capable of suppressing the deterioration of the positive electrode active material and an electrolytic solution and achieving a desirable discharge capacity.

(4) In a fourth aspect of the present invention according to any one of the first to third aspects, the solid particle includes an oxide.

The invention according to the fourth aspect can reduce a reaction resistance and suppress side reactions with an electrolytic solution.

(5) In a fifth aspect, of the present invention according to any one of the first to fourth aspects, with regard to weight ratios of the inorganic salt including lithium, the solid particle, and the organic material in the solid film, the weight ratio of the inorganic salt including lithium is the largest, the weight ratio of the solid particle is the second largest, and the weight ratio of the organic material is the smallest.

The invention of the fifth aspect, enables desirable lithium ion conductivity of a solid film to be obtained.

(6) In a sixth aspect of the present invention according to any one of the first to fifth aspects, the solid film has a thickness of 10 nm or more and 90 nm or less.

According to the invention of the sixth aspect, it is possible to provide a positive electrode active material capable of achieving desirable cycle characteristics of a lithium ion secondary battery.

(7) In a seventh aspect of the present invention according to any one of the first to sixth aspects, the lithium-containing transition metal oxide includes 60 mol %, or more of nickel atoms with respect to transition metal.

According to the invention of the seventh aspect, it is possible to provide a positive electrode active material capable of having high capacity and achieving a desirable discharge capacity of a lithium ion secondary battery.

### BRIEF DESCRIPTION OF THE DRAWINGS

FIG. 1 is a schematic diagram showing a positive electrode active material according to the present embodiment; and

FIG. 2 is a schematic diagram showing the positive electrode active material according to the present embodiment.

### DETAILED DESCRIPTION OF THE INVENTION

An embodiment of the present invention will now be described with reference to the drawings. The present invention is not limited to the following embodiment.

<Lithium Ion Secondary Battery>

A positive electrode active material according to the present embodiment is used as a positive electrode active material for a lithium ion secondary cattery. The lithium ion secondary battery according to the present embodiment includes a positive electrode in which a positive electrode active material layer including the positive electrode active material is formed on a positive electrode current collector. In addition to the above, the lithium ion secondary battery includes, for example, a negative electrode in which a negative electrode active material layer is formed on a negative electrode current collector, a separator that electrically insulates the positive electrode and the negative electrode, an electrolytic solution, and a container that houses these. In the container, the positive electrode active material layer and the negative electrode active material layer face each other with the separator interposed therebetween, and a part of the separator is immersed in the electrolytic solution stored in the container.

### (Current Collector)

As the material of the positive electrode current collector, for example, a foil-like, plate-like, or mesh-like member of copper, aluminum, nickel, chromium, gold, platinum, iron, zinc, titanium, or stainless steel can be used. As the material of the negative electrode current collector, for example, a foil-like, plate-like, or mesh-like member of copper, aluminum, nickel, titanium, stainless steel, calcined carbon, conductive polymer, conductive glass, or an Al—Cd alloy can be used.

### (Electrode Active Material Layer)

The positive electrode active material layer includes a positive electrode active material as an essential component, and may include a conductive auxiliary agent, a binder, and the like. Similarly, the negative electrode active material layer includes a negative electrode active material as an essential component, and may include a conductive auxiliary agent, a binder, and the like. The positive electrode active material layer and the negative electrode active material layer are each formed on at least one side of a corresponding current collector, and may be formed on both sides.

### [Positive Electrode Active Material]

The positive electrode active material is an aggregate of lithium compounds including a lithium-containing transition metal oxide. The lithium-containing transition metal oxide is a composite oxide containing a lithium element and a transition metal element. Examples of the lithium-containing transition metal oxide include lithium cobalt composite oxides such as LiCoO₂ and LiCoO₄, lithium manganese composite oxides such as LiMn₂O₄, lithium nickel composite oxides such as LiNiO₂, lithium nickel manganese composite oxides, and lithium-containing transition metal oxides such as LiNiₓCo_{y}Mn_{z}O₂ (x+y+z=1) and LiNiₓCO_{y}AlₓO₂ (x +y+z=1). As the lithium compound, a known lithium compound used as a positive electrode active material such as LiFePO₄, other than the above materials, may be included.

In the lithium-containing transition metal oxide, it is preferable that the proportion of Mi atoms with respect to the total number of transition metal atoms is 60 mol % or more. Thus, this enables high capacity of the positive electrode active material to be achieved. When the proportion of Ni atoms in the positive electrode active material is large, the volume change caused by charging and discharging increases, and thus the positive electrode active material tends to deteriorate. In the positive electrode active material according to the present embodiment, the deterioration of the positive electrode active material is suppressed by including a solid film (described later), which is preferable. Examples of the positive electrode active material having a proportion of Hi atoms of 60 mol % or more include NMC622 (Li(Ni_{0.6}Co_{0.2}Mn_{0.2})O₂, Ni: 60 mol %) and NHC811 (Li(Ni_{0.6}Co_{0.1}Mn_{0.1})O₂, Ni: 80 mol %).

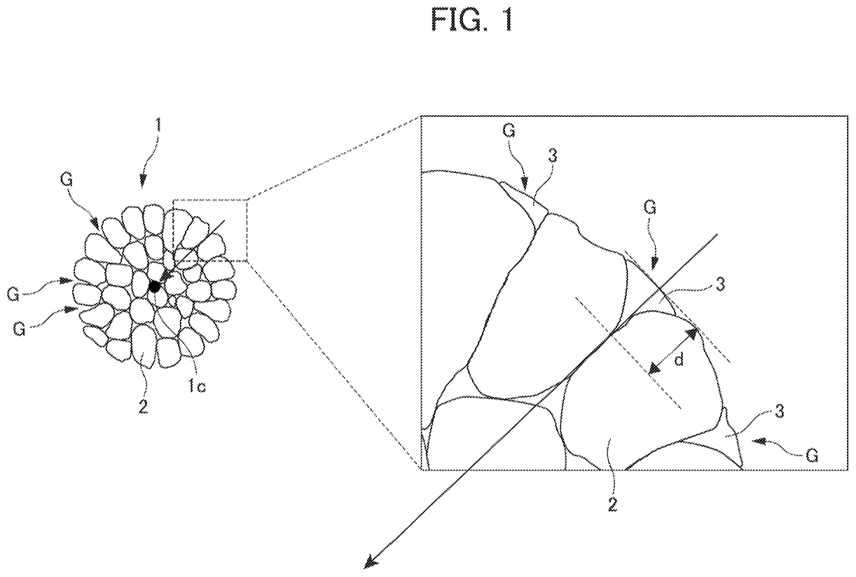

The configuration of the positive electrode active material will be described with reference to FIG. 1, which is a schematic diagram. As shown in FIG. 1, a positive electrode active material 1 according to the present embodiment is an aggregate of lithium compounds 2, which are primary particles. A solid film 3 including a plurality of lithium salts is formed on the surface of particles of the positive electrode active material 1. A recess G is formed between lithium compounds 2 that are primary particles.

### <<Solid Film>>

The solid film 3 prevents contact between the electrolytic solution and the positive electrode active material, and thereby suppresses decomposition of the electrolytic solution and deterioration of the positive electrode active material. Further, the solid film 3 has good lithium ion conductivity.

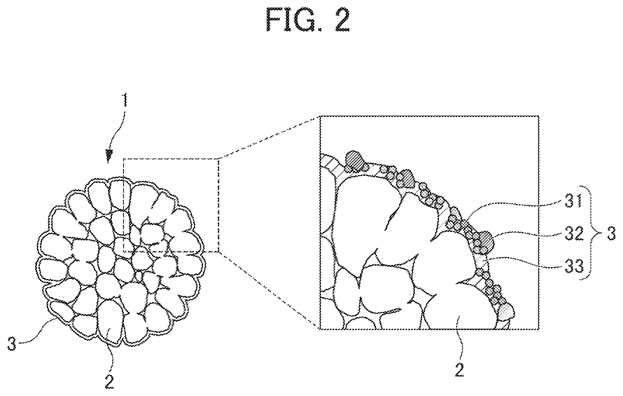

As shown in FIG. 1, the solid film 3 may fill the recess G. Alternatively, as shown in FIG. 2, the solid film 3 may coat the entire surface of the particles of the positive electrode active material 1.

The solid film 3 includes at least two of an inorganic salt 31 including lithium, a solid particle 32, and an organic material 33. As shown in FIG. 2, it is preferable that the solid film 3 includes all of the inorganic salt 31 including lithium, the solid particle 32, and the organic material 33.

The inorganic salt 31 including lithium has lithium ion conductivity, and allows lithium ions to be inserted into and released from inside the positive electrode active material. Examples of the inorganic salt 31 including lithium include fluorine compounds such as lithium fluoride (LiF), phosphorus compounds such as lithium phosphate (LiPO₃), and lithium carbonate (Li₂CO₃). It is preferable that the solid film 3 includes a fluorine compound such as lithium fluoride (LiF) and a phosphorus compound such as lithium phosphate (LiPO₃), as the inorganic salt 31 including lithium. Including lithium fluoride (LiF) in the solid film 3 enables a thin and dense solid film 3 to be formed. Further, lithium fluoride (LiF) is stable at a high potential and thus can suppress decomposition of the solid film 3, which is preferable. Including lithium phosphate (LiPO₃) in the solid film 3 can reduce the reaction resistance, which is preferable.

The inorganic salt 31 including lithium preferably contains 80 mol % or more of fluorine atoms with respect to the total number of moles of fluorine atoms and phosphorus atoms. This can suppress decomposition of the solid film 3 and an increase in the reaction resistance. In the solid film 3 formed in the recess G, it is preferable that the molar ratio of fluorine atoms to phosphorus atoms is greater than the molar ratio of the phosphorus atoms to the fluorine atoms. The atomic ratio in the solid film 3 can be measured by, for example. X-ray photoelectron spectroscopy (XPS).

The solid particle 32 suppresses the deterioration of the positive electrode active material by adsorbing the acid included in the electrolytic solution. The solid particle 32 is preferably an oxide. The polarization structure of the oxide generates electrostatic attraction between the solid film 3 and the lithium ions in the electrolytic solution, which allows the lithium ions to be concentrated at the reaction interface of the positive electrode. It is considered that this can reduce the reaction resistance and suppress side reactions with the electrolytic solution. As shown in FIG. 2, it is preferable that the solid particle 32 is disposed on the surface of the positive electrode active material 1, and is partially exposed so as to be in direct contact with the electrolytic solution. Examples of the solid particle 32 include yttrium oxide (Y₂O₃), yttria-stabilized zirconia (YSZ) in which yttrium oxide (Y₂O₃) is dissolved, Al₂O₃, SiO₂, MgO, and ZrO₂.

The organic material 33 improves the durability of the positive electrode active material by preventing the inorganic salt 31 including lithium and the solid particle 32 from falling off and preventing contact between the electrolytic solution and the positive electrode active material. As shown in FIG. 2, the organic material 33 is preferably disposed so as to fill the gap between the inorganic salts 31 including lithium. As the organic materiel 33, a thermosetting resin having heat resistance and chemical resistance can be preferably used. Examples of the organic material 33 include polyacrylic acid, polyvinyl acetate, polycarbonate, polyacrylonitrile, polyamide, polyimide, polyamide-imide, and derivatives (including copolymers) thereof.

In the solid film 3, since the solid particle 32 and the organic material 33 have low lithium ion conductivity, it is preferable that, with regard to the weight ratios of the inorganic salt 31 including lithium, the solid particle 32, and the organic material 33 in the solid film 3, the weight ratio of the inorganic salt 31 including lithium is the largest, the weight ratio of the solid particle 32 is the second largest, and the weight ratio of the organic material 33 is the smallest. That is, the weight ratios are preferably in the relationship of the inorganic salt 31 including lithium>the solid particle 32>the organic material 33.

The thickness of the solid film 3 is preferably 10 nm or more and 90 nm or less. When the thickness of the solid film 3 is 10 nm or more, an effect of preventing contact between the electrolytic solution and the positive electrode active material is preferably obtained. Further, when the thickness of the solid film 3 is 90 nm or less, cracking and peeling of the solid film 3 caused by a change in volume of the positive electrode active material can be suppressed. In this specification, the thickness of the solid film 3 is indicated by the thickness d in FIG. 1. The thickness d means the maximum thickness of the solid film 3 with respect to the surface of the positive electrode active material 1 that is in the form of particles when a perpendicular line (arrow in FIG. 1) is drawn from a tangent line of the surface of the positive electrode active material 1 to the center 1c of the positive electrode active material 1. The thickness can be measured with, for example, a transmission electron microscope (TEM).

When the solid film 3 does not include the organic material 33, the thickness of the solid film 3 is preferably 70 nm or less. This can suppress the peeling of the solid film 3. The thickness of the organic material 33 alone is preferably 20 nm or less. This enables desirable lithium ion conductivity of the solid film 3 to be obtained.

It is preferable that the solid film 3 has a coverage rate of 30% to 70%, which is the proportion of the surface area of the recess G covered by the solid film 3 formed with respect to the entire surface area of the recess G.

### (Negative Electrode Active Material)

The negative electrode active material is not limited, and for example, graphite is used. Examples of the graphite include soft carbon (easily graphitizable carbon) and hard carbon (non-graphitizable carbon). The graphite may be natural graphite or artificial graphite. One of the above may be used, or two or more of the above may be used in combination.

### [Conductive Auxiliary Agent]

Examples of the conductive auxiliary agent used in the positive electrode active material layer or the negative electrode active material include carbon black such as acetylene black (AB) and Ketjen black (KB), carbon material such as graphite powder, and conductive metal powder such as nickel powder. One of the above may be used, or two or more of the above may be used in combination.

### [Binder]

Examples of the binder used in the positive electrode active material layer or the negative electrode active material layer include a cellulose-based polymer, a fluorine-based resin, a vinyl acetate copolymer, and a rubber. Specifically, as a binder when a solvent-based dispersion medium is used, polyvinylidene fluoride (PVdF), polyimide (PI), polyvinylidene chloride (PVdC), polyethylene oxide (PEO), or the like can be used. As a binder when an aqueous dispersion medium is used, styrene butadiene rubber (SBR), acrylic acid-modified SBR resin (SBR-based latex), carboxymethyl cellulose (CMC), polyvinyl alcohol (PVA), polytetrafluoroethylene (PTFE), hydroxypropylmethylcellulose (HPMC), fluorinated ethylene propylene copolymer (FEP), or the like can be used. One of the above may be used, or two or more of the above may be used in combination.

### (Separator)

The separator is not limited, and examples of the separator include porous resin sheets (films, nonwoven fabrics, and the like) made of a resin such as polyethylene (PE), polypropylene (PP), polyester, cellulose, or polyamide.

### (Electrolytic Solution)

The electrolytic solution may be composed of a nonaqueous solvent and an electrolyte. The concentration of the electrolyte is preferably in the range of 0.1 to 10 mol/L.

### [Nonaqueous Solvent]

The nonaqueous solvent in included in the electrolytic solution is not limited, and examples thereof include aprotic solvents such as carbonates, esters, ethers, nitriles, sulfones, and lactones. Specifically, ethylene carbonate (EC), propylene carbonate (PC), diethyl carbonate (DSC), dimethyl carbonate (DMC), ethyl methyl carbonate (EMC), 1,2-dimethoxyethane (DME), 1,2-diethoxyethane (DEE), tetrahydrofuran (THF), 2-methyltetrahydrofuran, dioxane, 1,3-dioxolane, diethylene glycol dimethyl ether, ethylene glycol dimethyl ether, acetonitrile (AN), propionitrile, nitromethane, N,N-dimethylformamide (DMF), dimethyl sulfoxide, sulfolane, γ-butyrolactone, and the like may be used. One of the above may be used alone, or two or more of the above may be used in combination.

### [Electrolyte]

Examples of the electrolyte included in the electrolytic solution include LiPF₆, LiBF₄, LiClO₄, LiN(SO₂CF₃), LiN(SO₂C₂F₅)₂, LiCF₃SO₃, LiC₄F₉SO₃, LiC(SO₂CF₃)₃, LiF, LiCl, LiI, Li₂S, Li₃M, Li₃P, Li₁₀GeP₂S₁₂ (LGFS), Li₃PS₄, Li₆PS₅Cl, Li₇P₂S₈I, LiₓPO_{y}N_{z} (x=2y+3z−5, LiPON), Li_{y}La₃Zr₂O₁₂ (LLZO), Li₃ₓLa_{2/3-x}TiO₃ (LLTO), Li₁₊ₓAlₓTi_{2-z} (PO₄)₃ (0≤x≤1, LATP) , Li_{1.5}Al_{0.5}Ge_{1.5} (PO₄)₃ (LAGP), Li_{1+x+y}AlₓTi₂₋ₓSiyP_{3-y}O₁₂, Li_{1+x+y}Alₓ (Ti,Ge)₂₋ₓSiyP_{3-y}O₁₂, and Li₄₋₂ₓZnₓGeO₄ (LISICON). One of the above may be used alone, or two or more of the above may be used in combination.

### <Method for Manufacturing Positive Electrode Active Material>

A method for manufacturing the positive electrode active material according to the present embodiment includes at least two of the following coating processes: a coating process with an inorganic salt including lithium, a coating process with an organic material, and a coating process with a solid particle. It is preferable that the above processes are carried out in the above sequence. This allows the solid particle to be disposed on the outermost surface of the solid film and the organic material to be disposed in the gap between the inorganic salts including lithium. Each of the processes includes an immersion step of immersing a positive electrode active material in a film-forming component, a drying step, and a heat treatment step.

(Coating Process with Inorganic Salt Including Lithium)

In the immersion step in the coating process with an inorganic salt including lithium, a lithium compound aqueous solution can be used as the film-forming component. As the lithium compound aqueous solution, for example, a LiPF₆ aqueous solution can be used. Thus, a solid film including lithium fluoride (LiF) and lithium phosphate (LiPO₃) can be formed on the surface of the positive electrode active material.

In the drying step in the coating process with an inorganic salt including lithium, by drying the positive electrode active material immersed in the lithium compound aqueous solution at a predetermined temperature, a solid film including a plurality of types of lithium salts is formed on the surface of particles of the positive electrode active material. Since the lithium compound aqueous solution remains in the recess of the surface of the particles of the positive electrode active material after the drying step, the fluoride ions and lithium atoms in the lithium compound aqueous solution are bonded to each other, and thus lithium fluoride (LiF) is generated. Accordingly, it is possible to manufacture a positive electrode active material having a high ratio of LiF in the recess.

In the heat treatment step, a positive electrode active material precursor obtained in the drying step is subjected to heat treatment, and thus a positive electrode active material is obtained. The heat treatment conditions are 200° C. to 400° C., and heat treatment can be carried out under an atmosphere including oxygen in air or the like.

(Coating Process with Organic Material)

In the immersion step in the coating process with an organic material, the film-forming component is not limited. Examples thereof include a precursor of a resin component such as a thermosetting resin dispersed in a solvent. The drying and heat treatment steps in the coating process with an organic material can be the same as those described above. The heat treatment temperature can be, for example, 150° C. to 350° C. Therefore, a common heat treatment step may be carried out between the coating process with an organic material and the coating process with an inorganic salt including lithium. This can reduce the manufacturing cost of the positive electrode active material.

(Coating Process with a Solid Particle)

In the immersion step in the coating process with a solid particle, the film-forming component is not limited, and for example, a solid particle dispersed in a dispersoid such as a solvent can be used as appropriate. In the immersion step, it is preferable to disperse a positive electrode active material precursor in the above dispersion liquid. The drying and heat treatment steps in the coating process with a solid particle can be the same as those described above.

Although a preferred embodiment of the present invention has been described above, the content of the present invention is not limited to the above-described embodiment, and can be modified as appropriate.

### EXAMPLES

The content of the present invention will now be described in more detail based on examples. The content of the present invention is not limited to the description of the following examples.

### <Fabrication of Positive Electrode Active Material>

### Example 1

As a coating step with an inorganic salt including lithium, powder of Li₁Ni_{0.5}Co_{0.2}Mr_{0.2}O₂ as a positive electrode active material was immersed in a LiPF₆ aqueous solution. The amount of LiPF₆ was set to 0.7% with respect to the weight of the positive electrode active material. The above was dried while being stirred, and then subjected to heat treatment at 380° C. for 3 hours, and thereby a positive electrode active material precursor was obtained.

Subsequently, as a coating process with an organic material, a polyimide precursor varnish was dispersed in dimethylacetamide (DMA) to make a solution. The positive electrode active material dispersion obtained above was immersed in this solution, and the resulting product was stirred to dry and remove the DMA solvent. Then, the product was subjected to heat treatment in air under the conditions of 60° C. for 30 minutes, 120° C. for 30 minutes, 200° C. for 60 minutes, 300° C. for 60 minutes, and 400° C. for 10 minutes. Thus, a positive electrode active material precursor coated with an inorganic salt including lithium and an organic material was obtained.

Thereafter, as a coating process with a solid particle, yttria-stabilized zirconia (YSZ) particles in which yttrium oxide (Y₂O₃) is dissolved were dispersed in a sodium hexametaphosphate aqueous solution. Then, the positive electrode active material precursor coated with an inorganic salt including lithium and an organic material obtained above was dispersed in the above dispersion liquid. The resulting product was dried while being stirred, and then subjected to heat treatment at 400° C. for 10 minutes. Thus, the positive electrode active material of Example 1 was obtained.

### Examples 2 to 4, Comparative Examples 1 to 4

The positive electrode active materials of Examples 2 to 4 and Comparative Examples 1 to 4 were obtained in the same manner as in Example 2, except that the solid film-forming components of the positive electrode active materials were as shown in Table 1. In Comparative Example 1, a solid film was not formed.

### <Fabrication of Positive Electrode>

Positive electrodes were fabricated by using the positive electrode active materials of the above examples and comparative example. Acetylene black as a conductive auxiliary agent and polyvinylidene fluoride as a binder were premixed into N-methylpyrrolidone as a dispersion solvent, and thus a premixed slurry was obtained. Then, the positive electrode active material obtained as described above and the premixed slurry were mixed, the mixture was subjected to dispersion treatment, and thus a positive electrode paste was obtained. Subsequently, the obtained positive electrode paste was applied to an aluminum positive electrode current collector, and the resultant product was dried, pressurized, and then dried. Thus, a positive electrode including a positive electrode active material layer was fabricated.

### <Fabrication of Negative Electrode>

Acetylene black as a conductive auxiliary agent and carboxy methylcelluloae (CMC) as a binder were premixed. Subsequently, graphite as a negative electrode active material was mixed into the mixture, and the mixture was further premixed. Thereafter, water as a dispersion solvent was added, the mixture was subjected to dispersion treatment, and thus a negative electrode paste was obtained. Then, the obtained negative electrode paste was applied to a copper negative electrode current collector, and the resultant product was dried, pressurized, and then dried. Thus, a negative electrode including a negative electrode active material layer was fabricated.

### (Fabrication of Lithium Ion Secondary Battery)

A laminate, in which a separator was interposed between the positive electrode and the negative electrode fabricated above, was introduced into a pouch-like container prepared by heat-sealing an aluminum laminate for secondary batteries (manufactured by Dai Nippon Printing Co., Ltd.). Then, an electrolytic solution was injected into each electrode interface. Subsequently, the container was depressurized to −95 kPa and sealed, and thus a lithium ion secondary battery was fabricated. As the separator, a polyethylene microporous membrane coated on one side with about 5 μm of alumina particles was used. As the electrolytic solution, a solution obtained by dissolving LiPF₆ as an electrolyte salt at a concentration of 1.2 mol/L in a mixed solvent obtained by mixing ethylene carbonate, ethyl methyl carbonate, and dimethyl carbonate in a volume ratio of 30:30:40 was used.

### <Evaluation>

The following evaluations were performed using the positive electrode active materials of Examples 1 to 4 and Comparative Examples 1 to 4 and the lithium ion secondary batteries fabricated with these positive electrode active materials.

### [Initial Discharge Capacity]

The lithium ion secondary batteries fabricated with the positive electrode materials of the examples and comparative example were left; to stand at a measurement temperature of 25° C. for 1 hour, then were subjected to constant current charge at 3.4 mA to 4.2 V and subsequently to constant voltage charge at 4.2 V for 1 hour, then were left to stand for 30 minutes. Thereafter, the batteries were subjected to constant current discharge at a current value of 8.4 mA to 2.5 V. The above operation was repeated five times. The discharge capacity at the time of the fifth discharge was defined as the initial discharge capacity (mAh). The results are shown in Table 1. With respect to the discharge capacity obtained, the current value at which the discharge can be completed in 1 hour was defined as 1 C.

### [Initial Cell Resistance]

The lithium ion secondary batteries after the measurement of the initial discharge capacity were left to stand at a measurement temperature of 25° C. for 1 hour, then charged at 0.2 C, adjusted to a state of charge (SOC) of 50%, and left to stand for 10 minutes. Then, the lithium ion secondary batteries were subjected to pulse discharge at a C rate of 0.5 C for 10 seconds, and the voltage at the time of the completion of the 10 second discharge was measured. The voltage at the time of the completion of the 10 second discharge was plotted with respect to the current at 0.5 C, with the horizontal axis being the current value, and the vertical axis being the voltage. Subsequently, after being left to stand for 10 minutes, the lithium ion secondary batteries were subjected to auxiliary charge to reset the SOC to 50%, and further left to stand for 10 minutes. The above operation was performed at C rates of 1.0 C, 1.5 C, 2.0 C, 2.5 C, and 3.0 C, and the voltage at the time of the completion of the 10 second discharge was plotted with respect to the current value at each C rate. The slope of the approximate straight line obtained from each plot by a least-squares method was defined as the initial cell resistance value (Ω) of the lithium ion secondary battery of the example. The results are shown in Table 1.

[Discharge Capacity after Durability Test]

As a charge-discharge cycle durability test, one cycle was defined as an operation of constant current charge at a charge rate of 1 C to 4.2 V, and subsequent constant current discharge at a discharge rate of 2 C to 2.5 V in a thermostated bath at 45° C. This operation was repeated 500 cycles. After the completion of the 500 cycles, the thermostated bath was set to 25° C., and the lithium ion secondary battery was left to stand for 24 hours, subjected to constant current charge at 0.2 C to 4.2 V, subjected to subsequent, constant voltage charge at 4.2 V for 1 hour, and left to stand for 30 minutes. Subsequently, the battery was subjected to constant current discharge at a discharge rate of 0.2 C to 2.5 V, and the discharge capacity (mAh) after the durability test was measured. The results are shown in Table 1.

[Cell Resistance after Durability Test]

The lithium ion secondary batteries after the measurement of the discharge capacity after the durability test were charged so as to become a state of charge (SOC) of 50% in the same manner as in the measurement of the initial cell resistance value, and the cell resistance value (Ω) after the durability test was determined in the same manner as in the measurement of the initial cell resistance value. The cell resistance increase rate (%), which is the rate of the cell resistance value after the durability test with respect to the initial cell resistance value, was calculated. The results are shown in Table 1.

TABLE 1

| | Comparative | Comparative | Comparative | Comparative | | | | |
|---|---|---|---|---|---|---|---|---|
| | Example 1 | Example 2 | Example 3 | Example 4 | Example 1 | Example 2 | Example 3 | Example 4 |
| Solid film-forming | — | Li salt | Solid | Organic | Li salt + | Organic | Li salt + | Li salt + |
| component | | | particle | material | Solid | material + | Organic | Organic |
| | | | | | particle | Solid | material | material + |
| | | | | | | particle | | Solid |
| | | | | | | | | particle |
| Initial discharge | 42.5 | 42.0 | 43.1 | 42.4 | 42.7 | 42.5 | 41.9 | 43.0 |
| capacity (mAh) | | | | | | | | |
| Discharge capacity | 37.1 | 37.0 | 37.75 | 37.3 | 37.36 | 37.19 | 36.57 | 37.4 |
| after durability | | | | | | | | |
| test (mAh) | | | | | | | | |
| Initial cell | 1.00 | 0.96 | 0.98 | 1.10 | 0.99 | 1.05 | 0.98 | 0.93 |
| resistance (Ω) | | | | | | | | |
| Cell resistance | 1.43 | 1.25 | 1.27 | 1.47 | 1.24 | 1.35 | 1.22 | 1.11 |
| after durability | | | | | | | | |
| Cell resistance | 142.6 | 130.5 | 130.0 | 134.2 | 125.7 | 122.2 | 124.2 | 119.2 |
| increase rate (%) | | | | | | | | |

From the results in Table 1, it was confirmed that the lithium ion secondary batteries according to the examples each had a lower resistance increase rate than the lithium ion secondary batteries according to the comparative examples. That is, it was confirmed that the lithium ion secondary batteries according to the examples each had desirable cycle characteristics.

### EXPLANATION OF REFERENCE NUMERALS

1 positive electrode active material

2 lithium compound (primary particles)

3 solid film

31 Inorganic salt including lithium

32 Solid particle

33 Organic material

What is claimed is:

1. A positive electrode active material that is an aggregate of lithium compounds each comprising a lithium-containing transition metal oxide,
the positive electrode active material comprising particles having a surface on which a solid film comprising at least two of an inorganic salt including lithium, a solid particle, and an organic material, is formed.

2. The positive electrode active material according to claim 1, wherein the solid film comprises at least the organic material.

3. The positive electrode active material according to claim 1, wherein the solid film comprises the inorganic salt including lithium, the solid particle, and the organic material.

4. The positive electrode active material according to claim 1, wherein the solid particle comprises an oxide.

5. The positive electrode active material according to claim 1, wherein, with regard to weight ratios of the inorganic salt including lithium, the solid particle, and the organic material in the solid film, the weight ratio of the inorganic salt including lithium is the largest, the weight ratio of the solid particle is the second largest, and the weight ratio of the organic material is the smallest.

6. The positive electrode active material according to claim 1, wherein the solid film has a thickness of 10 nm or more and 90 nm or less.

7. The positive electrode active material according to claim 1, wherein the lithium-containing transition metal oxide comprises 60 mol % or more of nickel atoms with respect to transition metal.
